(19) United States
(12) Patent Application Publication
(10) Pub. No.: US 2025/0270706 A1
(43) Pub. Date: Aug. 28, 2025

(54) CORROSION INHIBITOR COMPOSITIONS AND METHODS OF USING THE COMPOSITIONS TO INHIBIT CORROSION

(71) Applicant: ChampionX LLC, Sugar Land, TX (US)

(72) Inventor: Jeremy MOLONEY, Katy, TX (US)

(73) Assignee: ChampionX LLC, Sugar Land, TX (US)

(21) Appl. No.: 19/061,344

(22) Filed: Feb. 24, 2025

Related U.S. Application Data
(60) Provisional application No. 63/558,296, filed on Feb. 27, 2024.

(51) Int. Cl. C23F 11/16; C02F 5/12; C02F 101/10; C02F 103/02; C02F 103/10; C09K 8/54; C23F 11/14

(52) U.S. Cl. CPC C23F 11/16; C02F 5/12; C09K 8/54; C23F 11/149; C02F 2101/101; C02F 2103/023; C02F 2103/10; C02F 2303/08; C09K 2208/20; C09K 2208/32

(57) ABSTRACT

Compositions and methods for inhibiting corrosion of metal surfaces and reducing levels of hydrogen sulfide are disclosed herein. A composition may include a nitrogen-containing alicyclic compound and/or a thio-containing compound. The nitrogen-containing alicyclic compound and the thio-containing compound may be added to a medium in contact with a metal surface and/or they may be added directly to a metal surface. Other components may be added as well, such as a biocide and/or a scale inhibitor.

### TECHNICAL FIELD

The present disclosure generally relates to methods and compositions useful for inhibiting corrosion of metallic surfaces and reducing hydrogen sulfide.

### BACKGROUND

Aqueous liquids are injected into the earth and/or recovered from the earth during subterranean hydrocarbon recovery processes. In some processes, an aqueous liquid called an “injectate” is injected into a subterranean formation and a water source called “produced water” is recovered, i.e., flows back from the subterranean formation and is collected along with a hydrocarbon product. The injectate and the produced water may include one or more corrodents, such as salts and/or other dissolved solids, liquids, or gases that cause, accelerate, or promote corrosion of metal surfaces and/or containments, such as metal pipelines and metal tanks.

Corrosion inhibitors are typically added into upstream oil and gas production fluids to protect and reduce corrosion of metal surfaces that are contacted by liquids containing corrodents. Corrosion inhibitors are added to the liquids and dissolved gasses that come into contact with the metal surfaces and they act to prevent, retard, delay, reverse, and/or otherwise inhibit corrosion of the metal surfaces.

Sulfur-based compounds are known to be effective corrosion inhibitors and are favored because they are inexpensive. However, some sulfur-based corrosion inhibitors are known to produce hydrogen sulfide gas. Hydrogen sulfide is a known corrodent recognized to cause severe corrosion issues. Hydrogen sulfide is toxic and dissolves in both hydrocarbon (oil/gasoline) and water streams. Further, hydrogen sulfide is a flammable gas, providing a severe health and safety risk.

### BRIEF SUMMARY

The present disclosure provides compositions and methods for inhibiting corrosion of metal surfaces and reducing hydrogen sulfide levels in a medium. In some embodiments, the disclosure provides a method of inhibiting corrosion of a metal surface in contact with a medium. The method comprises adding an effective amount of a nitrogen-containing alicyclic compound to the medium and adding an effective amount of a thio-containing compound to the medium. The nitrogen-containing alicyclic compound may be selected from the group consisting of piperazine, aziridine, azetidine, pyrrolidine, piperidine, dihydroazete, diazetidine, triazinane, and any combination thereof.

The present disclosure also provides compositions that are useful for inhibiting corrosion of metal surfaces. A composition of the present disclosure may comprise a medium, a nitrogen-containing alicyclic compound, and a thio-containing compound. The medium may comprise produced water, fresh water, recycled water, salt water, surface water, condensed water, cooling water, injection water, waste water, geothermal waters, sewage water, nuclear cooling water, or any mixture thereof. The nitrogen-containing alicyclic compound may be selected from the group consisting of piperazine, aziridine, azetidine, pyrrolidine, piperidine, dihydroazete, diazetidine, triazinane, and any combination thereof.

Finally, the present disclosure provides a method of reducing an amount of hydrogen sulfide. The method comprises adding a nitrogen-containing alicyclic compound to a medium, the medium comprising hydrogen sulfide and a thio-containing compound. The method also comprises reacting the nitrogen-containing alicyclic compound with the thio-containing compound and/or the hydrogen sulfide, and reducing an amount of hydrogen sulfide in the medium.

The foregoing has outlined rather broadly the features and technical advantages of the present disclosure in order that the detailed description that follows may be better understood. Additional features and advantages of the disclosure will be described hereinafter that form the subject of the claims of this application. It should be appreciated by those skilled in the art that the conception and the specific embodiments disclosed may be readily utilized as a basis for modifying or designing other embodiments for carrying out the same purposes of the present disclosure. It should also be realized by those skilled in the art that such equivalent embodiments do not depart from the spirit and scope of the disclosure as set forth in the appended claims.

### DETAILED DESCRIPTION

The present disclosure provides compositions and methods for inhibiting corrosion of metallic surfaces.

Unless otherwise indicated, an alkyl group as described herein—alone or as part of another group—is an optionally substituted linear or branched saturated monovalent hydrocarbon substituent containing from, for example, one to about sixty carbon atoms, such as one to about thirty carbon atoms, in the main chain. Examples of unsubstituted alkyl groups include methyl, ethyl, n-propyl, i-propyl, n-butyl, i-butyl, s-butyl, t-butyl, n-pentyl, i-pentyl, s-pentyl, t-pentyl, and the like.

Compounds of the present disclosure may be substituted with suitable substituents. The term “suitable substituent,” as used herein, is intended to mean a chemically acceptable functional group, preferably a moiety that does not negate the activity of the compounds. Such suitable substituents include, but are not limited to, halo groups, perfluoroalkyl groups, perfluoro-alkoxy groups, alkyl groups, alkenyl groups, alkynyl groups, hydroxy groups, oxo groups, mercapto groups, alkylthio groups, alkoxy groups, aryl or heteroaryl groups, aryloxy or heteroaryloxy groups, aralkyl or heteroaralkyl groups, aralkoxy or heteroaralkoxy groups, HO—(C═O)— groups, heterocylic groups, cycloalkyl groups, amino groups, alkyl- and dialkylamino groups, carbamoyl groups, alkylcarbonyl groups, alkoxycarbonyl groups, alkylaminocarbonyl groups, dialkylamino carbonyl groups, arylcarbonyl groups, aryloxy-carbonyl groups, alkylsulfonyl groups, and arylsulfonyl groups. In some embodiments, suitable substituents may include halogen, an unsubstituted C₁-C₁₂ alkyl group, an unsubstituted C₄-C₆ aryl group, or an unsubstituted C₁-C₁₀ alkoxy group. Those skilled in the art will appreciate that many substituents can be substituted by additional substituents.

The term “substituted” as in “substituted alkyl,” means that in the group in question (e.g., the alkyl group), at least one hydrogen atom bound to a carbon atom is replaced with one or more substituent groups, such as hydroxy (—OH), alkylthio, phosphino, amido (—CON(R_{A})(R_{B}), wherein R_{A} and R_{B} are independently hydrogen, alkyl, or aryl), amino(-N(R_{A})(R_{B}), wherein R_{A} and R_{B} are independently hydrogen, alkyl, or aryl), halo (fluoro, chloro, bromo, or iodo), silyl, nitro (—NO₂), an ether (—OR_{A} wherein R_{A} is alkyl or aryl), an ester (—OC(O)R_{A} wherein R_{A} is alkyl or aryl), keto (—C(O)R_{A} wherein R_{A} is alkyl or aryl), heterocyclo, and the like.

When the term “substituted” introduces a list of possible substituted groups, it is intended that the term apply to every member of that group. That is, the phrase “optionally substituted alkyl or aryl” is to be interpreted as “optionally substituted alkyl or optionally substituted aryl.”

The terms “polymer,” “copolymer,” “polymerize,” “copolymerize,” and the like include not only polymers comprising two monomer residues and polymerization of two different monomers together, but also include (co)polymers comprising more than two monomer residues and polymerizing together more than two or more other monomers. For example, a polymer as disclosed herein includes a terpolymer, a tetrapolymer, polymers comprising more than four different monomers, as well as polymers comprising, consisting of, or consisting essentially of two different monomer residues. Additionally, a “polymer” as disclosed herein may also include a homopolymer, which is a polymer comprising a single type of monomer unit.

Unless specified differently, the polymers of the present disclosure may be linear, branched, crosslinked, structured, synthetic, semi-synthetic, natural, and/or functionally modified. A polymer of the present disclosure (or a composition, compound, component, etc.) can be in the form of a solution, a dry powder, a liquid, or a dispersion, for example.

In some embodiments, the present disclosure provides a nitrogen-containing alicyclic compound and a thio-containing compound. A composition may comprise, consist of, or consist essentially of the nitrogen-containing alicyclic compound. A composition may comprise, consist of, or consist essentially of the thio-containing compound. In certain embodiments, a composition may comprise, consist of, or consist essentially of a nitrogen-containing alicyclic compound and a thio-containing compound.

The present inventor discovered that the addition of a nitrogen-containing alicyclic compound, or a derivative thereof, to a medium comprising the thio-containing compound reduced, eliminated, or substantially eliminated evolution of toxic hydrogen sulfide gas from the thio-containing compound.

Illustrative, non-limiting examples of nitrogen-containing alicyclic compounds include piperazine, aziridine, azetidine, azepane, quinuclidine, pyrrolidine, piperidine, dihydroazete, diazetidine, triazinane, and any combination thereof.

Illustrative, non-limiting examples of thio-containing compounds include 2-mercaptoethanol, thioglycolic acid, a thiosulfate, and any combination thereof. In certain embodiments, the thio-containing compound excludes a hydroxyl group. In certain embodiments, the thio-containing compounds are water-soluble and in other embodiments, the thio-containing compounds are not soluble in water.

A composition of the present disclosure may comprise, consist of, or consist essentially of, for example, piperazine and 2-mercaptoethanol.

A composition of the present disclosure may include any amount of the nitrogen-containing compound. For example, the composition may comprise from about 0.5 wt. % to about 99 wt. % of the nitrogen-containing compound, such as from about 0.5 wt. % to about 90 wt. %, about 0.5 wt. % to about 80 wt. %, about 0.5 wt. % to about 70 wt. %, about 0.5 wt. % to about 60 wt. %, about 0.5 wt. % to about 50 wt. %, about 0.5 wt. % to about 40 wt. %, about 0.5 wt. % to about 30 wt. %, about 0.5 wt. % to about 20 wt. %, about 0.5 wt. % to about 10 wt. %, or about 0.5 wt. % to about 5 wt. % of the nitrogen-containing compound.

A composition of the present disclosure may include any amount of the thio-containing compound. For example, the composition may comprise from about 0.5 wt. % to about 99 wt. % of the thio-containing compound, such as from about 0.5 wt. % to about 90 wt. %, about 0.5 wt. % to about 80 wt. %, about 0.5 wt. % to about 70 wt. %, about 0.5 wt. % to about 60 wt. %, about 0.5 wt. % to about 50 wt. %, about 0.5 wt. % to about 40 wt. %, about 0.5 wt. % to about 30 wt. %, about 0.5 wt. % to about 20 wt. %, about 0.5 wt. % to about 10 wt. %, or about 0.5 wt. % to about 5 wt. % of the thio-containing compound.

In certain embodiments, a composition disclosed herein may comprise one or more solvents. For example, a composition in accordance with the present disclosure may comprise a solvent selected from water, a C₁-C₆ alkanol, a C₁-C₆ alkoxyalkanol, an alcohol, a glycol ether, a hydrocarbon, a ketone, an ether, an aromatic, an alkylene glycol, an amide, a nitrile, a sulfoxide, an ester, and any combination thereof.

In some embodiments, a composition of the present disclosure may be in the form of a liquid, a gel, or a mixture thereof.

In certain embodiments, a composition disclosed herein may comprise a pH from about 1 to about 10. In some embodiments, the pH of the composition may be from about 1 to about 9, from about 1 to about 8, from about 1 to about 7, from about 1 to about 6, from about 1 to about 5, from about 1 to about 4, from about 3 to about 10, from about 3 to about 8, from about 3 to about 6, from about 5 to about 10, from about 5 to about 8, from about 5 to about 7, from about 4 to about 7, or from about 4 to about 6.

The present disclosure also provides methods of inhibiting corrosion of a metal surface in contact with a medium. The methods comprise adding an effective amount of a nitrogen-containing alicyclic compound to the medium and/or metal surface and adding a thio-containing compound to the medium and/or metal surface. Any of the compositions disclosed in the present application comprising, consisting of, or consisting essentially of the nitrogen-containing alicyclic compound and/or the thio-containing compound may be added to the medium and/or metal surface. The nitrogen-containing alicyclic compound and/or the thio-containing compound (or a composition comprising the nitrogen-containing alicyclic compound and/or the thio-containing compound may be added continuously, intermittently, automatically, manually, and/or in any order.

In some embodiments, the effective amount of the nitrogen-containing alicyclic compound added to the medium is from about 1 ppm to about 50,000 ppm. For example, the effective amount may be from about 1 ppm to about 45,000 ppm, from about 1 ppm to about 40,000 ppm, from about 1 ppm to about 35,000 ppm, from about 1 ppm to about 30,000 ppm, from about 1 ppm to about 25,000 ppm, from about 1 ppm to about 20,000 ppm, from about 1 ppm to about 15,000 ppm, from about 1 ppm to about 10,000 ppm, from about 1 ppm to about 5,000 ppm, from about 1 ppm to about 4,000 ppm, from about 1 ppm to about 3,000 ppm, from about 1 ppm to about 2,000 ppm, from about 1 ppm to about 1,000 ppm, from about 1 ppm to about 750 ppm, from about 1 ppm to about 500 ppm, from about 10 ppm to about 500 ppm, from about 50 ppm to about 500 ppm, from about 100 ppm to about 500 ppm, or from about 250 ppm to about 500 ppm.

In some embodiments, the effective amount of the thio-containing compound added to the medium is from about 1 ppm to about 50,000 ppm. For example, the effective amount may be from about 1 ppm to about 45,000 ppm, from about 1 ppm to about 40,000 ppm, from about 1 ppm to about 35,000 ppm, from about 1 ppm to about 30,000 ppm, from about 1 ppm to about 25,000 ppm, from about 1 ppm to about 20,000 ppm, from about 1 ppm to about 15,000 ppm, from about 1 ppm to about 10,000 ppm, from about 1 ppm to about 5,000 ppm, from about 1 ppm to about 4,000 ppm, from about 1 ppm to about 3,000 ppm, from about 1 ppm to about 2,000 ppm, from about 1 ppm to about 1,000 ppm, from about 1 ppm to about 750 ppm, from about 1 ppm to about 500 ppm, from about 10 ppm to about 500 ppm, from about 50 ppm to about 500 ppm, from about 100 ppm to about 500 ppm, or from about 250 ppm to about 500 ppm.

In some embodiments, the medium is an aqueous medium, such as produced water, seawater, municipal water, “gray” water, brackish water, fresh water, recycled water, salt water, surface water, connate, groundwater, wastewater, or any combination of the foregoing. The aqueous medium may be a continuously flowing medium, such as produced water flowing from a subterranean reservoir and into or through a pipe or tank. The aqueous medium may also be, for example, wastewater isolated from a continuous manufacturing process flowing into a wastewater treatment apparatus. In other embodiments, the aqueous medium is a batch, or plug, substantially disposed in a batchwise or static state within a metal containment.

The presently disclosed compounds and compositions are useful for inhibiting corrosion of metal surfaces in contact with any type of corrodent in the medium, such as metal cations, metal complexes, metal chelates, organometallic complexes, aluminum ions, ammonium ions, barium ions, chromium ions, cobalt ions, cuprous ions, cupric ions, calcium ions, ferrous ions, ferric ions, hydrogen ions, magnesium ions, manganese ions, molybdenum ions, nickel ions, potassium ions, sodium ions, strontium ions, titanium ions, uranium ions, vanadium ions, zinc ions, bromide ions, carbonate ions, chlorate ions, chloride ions, chlorite ions, dithionate ions, fluoride ions, hypochlorite ions, iodide ions, nitrate ions, nitrite ions, oxide ions, perchlorate ions, peroxide ions, phosphate ions, phosphite ions, sulfate ions, sulfide ions, sulfite ions, hydrogen carbonate ions, hydrogen phosphate ions, hydrogen phosphite ions, hydrogen sulfate ions, hydrogen sulfite ions, an acid, such as carbonic acid, hydrochloric acid, nitric acid, sulfuric acid, nitrous acid, sulfurous acid, a peroxy acid, or phosphoric acid, ammonia, bromine, carbon dioxide, chlorine, chlorine dioxide, fluorine, hydrogen chloride, hydrogen sulfide, iodine, nitrogen dioxide, nitrogen monoxide, oxygen, ozone, sulfur dioxide, hydrogen peroxide, polysaccharides, metal oxides, sands, clays, silicon dioxide, titanium dioxide, muds, insoluble inorganic and/or organic particulates, an oxidizing agent, a chelating agent, an alcohol, and any combination of the foregoing.

In some embodiments, the medium is an aqueous medium with a pH of about 1 to about 14. For example, the aqueous medium may have a pH less than about 7, such as from about 1 to about 6.5, or greater than about 7, such as from about 7.5 to about 14. In some embodiments, the pH of the aqueous medium is between about 1 and about 6, about 2 and about 6, about 3 and about 6, about 4 and about 6, and about 5 and about 6. In some embodiments, the pH of the aqueous medium is between about 7 and about 14. For example, the pH may be about 7 to about 12, about 7 to about 10, or about 7 to about 8.

In some embodiments, the aqueous medium comprises from about 1 ppm to about 50,000 ppm, by weight or by volume, of the nitrogen-containing alicyclic compound. In some embodiments, the aqueous medium comprises from about 1 ppm to about 40,000 ppm, from about 1 ppm to about 30,000 ppm, from about 1 ppm to about 20,000 ppm, from about 1 ppm to about 10,000 ppm, from about 1 ppm to about 5,000 ppm, from about 1 ppm to about 1,000 ppm, or from about 1 ppm to about 500 ppm of the nitrogen-containing alicyclic compound.

In some embodiments, the aqueous medium comprises from about 1 ppm to about 50,000 ppm, by weight or by volume, of the thio-containing compound. In some embodiments, the aqueous medium comprises from about 1 ppm to about 40,000 ppm, from about 1 ppm to about 30,000 ppm, from about 1 ppm to about 20,000 ppm, from about 1 ppm to about 10,000 ppm, from about 1 ppm to about 5,000 ppm, from about 1 ppm to about 1,000 ppm, or from about 1 ppm to about 500 ppm of the thio-containing compound.

The presently disclosed compounds, compositions, and methods are useful for inhibiting corrosion of any metal surfaces. In some embodiments, the metal surface comprises steel, such as stainless steel or carbon steel. In some embodiments, the metal surface comprises iron, aluminum, zinc, chromium, manganese, nickel, tungsten, molybdenum, titanium, vanadium, cobalt, niobium, or copper. The metal surface may also comprise any combination of the foregoing metals and/or any one or more of boron, phosphorus, sulfur, silicon, oxygen, and nitrogen. In certain embodiments, the metal comprises a carbon steel and/or a carbon steel alloy, stainless steel and/or a stainless steel alloy, or a yellow metal and/or a yellow metal alloy.

In some embodiments, a pipe or a tank (e.g., railroad tank car or a tank truck/tanker) comprises the metal surface.

In addition to inhibiting corrosion, the methods of the present disclosure can additionally or alternatively reduce levels of hydrogen sulfide in any medium disclosed herein. A method may include adding a nitrogen-containing alicyclic compound to a medium and adding a thio-containing compound to the medium. The amounts added are as described herein in connection with corrosion inhibition. The thio-containing compound may react with a component in the medium and produce hydrogen sulfide. However, the nitrogen-containing alicyclic compound may react with/stabilize the thio-containing compound such that it cannot produce hydrogen sulfide. The nitrogen-containing alicyclic compound may additionally or alternatively react with any hydrogen sulfide present in the medium, thereby eliminating it from the medium or at least lowering an amount of the hydrogen sulfide present in the medium.

In some embodiments, the methods disclosed herein further comprise adding a component to the medium. The component may be added before, after, and/or with the nitrogen-containing alicyclic compound. The component may be added before, after, and/or with the thio-containing compound. The component may be added continuously, automatically, intermittently, and/or manually.

In some embodiments, a composition comprising, consisting of, or consisting essentially of the nitrogen-containing alicyclic compound further includes the component and an optional solvent. In certain embodiments, a composition comprising, consisting of, or consisting essentially of the thio-containing compound further includes the component and an optional solvent. In some embodiments, a composition comprising, consisting of, or consisting essentially of the nitrogen-containing alicyclic compound and the thio-containing compound further includes the component and an optional solvent.

Illustrative, non-limiting examples of components include a fouling control agent, an additional corrosion inhibitor, a biocide, a preservative, an acid, a hydrogen sulfide scavenger, a surfactant, an asphaltene inhibitor, a paraffin inhibitor, a scale inhibitor, a gas hydrate inhibitor, a pH modifier, an emulsion breaker, a reverse emulsion breaker, a coagulant/flocculant agent, an emulsifier, a water clarifier, a dispersant, an antioxidant, a polymer degradation prevention agent, a permeability modifier, a foaming agent, an antifoaming agent, a CO₂ scavenger, an O₂ scavenger, a gelling agent, a lubricant, a friction reducing agent, a salt, and any combination thereof.

The additional corrosion inhibitor may comprise, for example, an imidazoline compound, a pyridinium compound, a quaternary ammonium compound, a phosphate ester, an amine, an amide, a carboxylic acid, a thiol, and any combination thereof.

The fouling control agent may comprise, for example, a quaternary compound.

Illustrative, non-limiting examples of biocides include chlorine, hypochlorite, ClO₂, bromine, ozone, hydrogen peroxide, peracetic acid, peroxycarboxylic acid, peroxycarboxylic acid composition, peroxysulphate, glutaraldehyde, dibromonitrilopropionamide, isothiazolone, terbutylazine, polymeric biguanide, methylene bisthiocyanate, tetrakis hydroxymethyl phosphonium sulphate, and any combination thereof.

The acid may comprise, for example, hydrochloric acid, hydrofluoric acid, citric acid, formic acid, acetic acid, or any combination thereof.

The hydrogen sulfide scavenger may comprise, for example, an oxidant, inorganic peroxide, chlorine dioxide, a C₁-C₁₀ aldehyde, formaldehyde, glyoxal, glutaraldehyde, acrolein, methacrolein, a triazine, or any combination thereof.

The surfactant may be non-ionic, cationic, anionic, amphoteric, or zwitterionic.

When a composition comprises a component (or combination of components), it generally comprises from about 0.1 wt. % to about 40 wt. % of the component. For example, the composition may comprise from about 0.1 wt. % to about 35 wt. %, from about 0.1 wt. % to about 30 wt. %, from about 0.1 wt. % to about 25 wt. %, from about 0.1 wt. % to about 20 wt. %, from about 0.1 wt. % to about 15 wt. %, from about 0.1 wt. % to about 10 wt. %, from about 0.1 wt. % to about 5 wt. %, or from about 0.1 wt. % to about 1 wt. % of the component.

The nitrogen-containing alicyclic compound, thio-containing compound, component, etc., may be added to the medium and/or metal surface neat, dissolved in a solvent, partially dissolved in a solvent, and/or dispersed in a solvent. The addition may involve manual addition, automatic addition, dripping, pouring, spraying, pumping, injecting, or otherwise adding the nitrogen-containing alicyclic compound, thio-containing compound, component, etc., to the medium and/or the metal surface. In some embodiments, a compound, composition, component, etc., may be heated, such as to about 30° C., about 40° C., about 50° C., about 60° C., about 70° C., about 80° C., about 90° C., about 100° C., or greater than about 100° C., prior to addition.

In some embodiments, the medium and/or metal surface to be treated with the presently disclosed compounds, compositions, components, etc., may be located in a cooling water system, a boiler water system, a petroleum well, a downhole formation, a geothermal well, a mineral washing process, a flotation and benefaction process, a papermaking process, a gas scrubber, an air washer, a continuous casting processes, an air conditioning and refrigeration process, a water reclamation process, a water purification process, a membrane filtration process, a clarifier, a municipal sewage treatment process, a municipal water treatment process, or a potable water system.

The foregoing may be better understood by reference to the following examples, which are intended for illustrative purposes and are not intended to limit the scope of the disclosure or its application in any way.

### Examples

Various amounts of 2-mercaptoethanol and piperazine were separately mixed together to form a number of different blends. Each blend was then assessed for headspace hydrogen sulfide and compared to 2-mercaptoethanol by itself.

In particular, about 40 gram blends of about 5% w/w 2-mercaptoethanol with varying amounts of piperazine were prepared in water in 4 ounce French square bottles and stored in a temperature-controlled cabinet for 7 days at elevated temperature (about 50° C.). Then, the amount of hydrogen sulfide gas in the headspace of each bottle was measured using hydrogen sulfide detector tubes.

The components of the blends and the results of the experiments are shown in Table 1.

TABLE 1

| | % (w/w) 2- | % (w/w) | |
|---|---|---|---|
| Blend No. | mercaptoethanol | piperazine | H₂S (ppm) |
| 1 | 5 | 0 | >500 |
| 2 | 5 | 0.5 | 50 |
| 3 | 5 | 1 | 25 |
| 4 | 5 | 2 | 10 |
| 5 | 5 | 5 | Not detectable |
| 6 | 5 | 7.5 | Not detectable |
| 7 | 5 | 10 | Not detectable |

The data show that a composition comprising 2-mercaptoethanol and piperazine had little or no hydrogen sulfide present in the headspace while a composition comprising 2-mercaptoethanol but no piperazine had large levels of hydrogen sulfide present in the headspace.

In another series of experiments, blends of 2-mercaptoethanol and piperazine were tested for corrosion performance. Bubble Cell tests were carried out with a carbon steel electrode (C1018 grade). The corrosion rate was assessed electrochemically using linear polarization resistance (LPR) methodology.

The following conditions were used: about 80° C., CO₂ saturated fluids with 3% NaCl brine (100% brine) with continuous CO₂ sparge, atmospheric pressure. A pre-corrosion time (i.e., with no corrosion inhibitor) was carried out for about 2-3 hours before either 50 ppm of COMP 1 (5 wt. % 2-mercaptoethanol in water), 50 ppm of COMP 2 (5 wt. % piperazine in water), or 25 ppm of COMP 3 (about 5 wt. % 2-mercaptoethanol and about 5 wt. % piperazine in water). This equated to 2.5 ppm total active chemistry being introduced into the test cell. The inhibited corrosion rate at about 15 hours after COMP 1, 2, or 3 injection was noted and a percentage inhibition determined by comparing with the corrosion rate of a carbon steel electrode under otherwise the same conditions in the absence of corrosion inhibitor after the same time of exposure to the corrosive environment.

The results gained are shown in Table 2. It can be seen that 2.5 ppm of COMP 3 (i.e., about 1.25 ppm of 2-mercaptoethanol and about 1.25 ppm piperazine) resulted in much better corrosion inhibition compared with 2.5 ppm of each of the chemistries when injected individually. Accordingly, Applicant discovered unexpected synergy between certain components of the compositions disclosed herein.

TABLE 2

| | | | | Amount | | | | |
|---|---|---|---|---|---|---|---|---|
| | | | | of 2- | Amount | | | |
| | | | Dose of | Mercapto- | of | | | |
| | | | Blend | ethanol | Piperazine | | | |
| | Amount | | [based | dosed | dosed | | Corrosion | |
| | of 2- | Amount | on | [based on | [based on | Total | Rate After | |
| | Mercapto- | of | water | water | water | Chemistry | 15 h of Cl | |
| | ethanol | Piperazine | phase] | phase] | phase] | Dosed | Injection | % |
| Additive | (wt %) | (wt %) | (ppm) | (ppm) | (ppm) | (ppm) | (mpy) | Protection |
| Blank | N/A | N/A | N/A | N/A | N/A | N/A | 502 | N/A |
| COMP 1 | 5.0 | 0.0 | 50 | 2.50 | 0.00 | 2.50 | 84 | 83 |
| COMP 2 | 0.0 | 5.0 | 50 | 0.00 | 2.50 | 2.50 | 444 | 12 |
| COMP 3 | 5.0 | 5.0 | 25 | 1.25 | 1.25 | 2.50 | 40 | 92 |

All of the compositions and methods disclosed and claimed herein can be made and executed without undue experimentation in light of the present disclosure. While this invention may be embodied in many different forms, there are described in detail herein specific preferred embodiments of the invention. The present disclosure is an exemplification of the principles of the invention and is not intended to limit the invention to the particular embodiments illustrated. In addition, unless expressly stated to the contrary, use of the term “a” is intended to include “at least one” or “one or more.” For example, “a thio-containing compound” is intended to include “at least one thio-containing compound” or “one or more thio-containing compounds.”

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges (including all fractional and whole values) subsumed therein.

Any composition disclosed herein may comprise, consist of, or consist essentially of any element, compound, component and/or ingredient disclosed herein or any combination of two or more of the elements, components or ingredients disclosed herein.

Any method disclosed herein may comprise, consist of, or consist essentially of any method step disclosed herein or any combination of two or more of the method steps disclosed herein.

The transitional phrase “comprising,” which is synonymous with “including,” “containing,” or “characterized by,” is inclusive or open-ended and does not exclude additional, un-recited elements, compounds, components, ingredients and/or method steps.

The transitional phrase “consisting of” excludes any element, compound, component, ingredient, and/or method step not specified in the claim.

The transitional phrase “consisting essentially of” limits the scope of a claim to the specified elements, compound, components, ingredients and/or steps, as well as those that do not materially affect the basic and novel characteristic(s) of the claimed invention.

Unless specified otherwise, all molecular weights referred to herein are weight average molecular weights and all viscosities were measured at 25° C. with neat (not diluted) polymers.

As used herein, the term “about” refers to the cited value being within the errors arising from the standard deviation found in their respective testing measurements, and if those errors cannot be determined, then “about” may refer to, for example, within 5%, 4%, 3%, 2%, or 1% of the cited value.

Furthermore, the invention encompasses any and all possible combinations of some or all of the various embodiments described herein. It should also be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

What is claimed is:

1. A method of inhibiting corrosion of a metal surface in contact with a medium, comprising:
adding an effective amount of a nitrogen-containing alicyclic compound to the medium, and
adding an effective amount of a thio-containing compound to the medium,
wherein the nitrogen-containing alicyclic compound is selected from the group consisting of piperazine, aziridine, azetidine, azepane, quinuclidine, pyrrolidine, piperidine, dihydroazete, diazetidine, triazinane, and any combination thereof.

2. The method of claim 1, wherein the thio-containing compound is selected from the group consisting of 2-mercaptoethanol, thioglycolic acid, a thiosulfate, and any combination thereof.

3. The method of claim 1, wherein a composition comprises from about 0.5 wt. % to about 99 wt. % of the nitrogen-containing alicyclic compound and/or from about 0.5 wt. % to about 99 wt. % of the thio-containing compound.

4. The method of claim 3, wherein the composition comprises a pH from about 2 to about 10.

5. The method of claim 1, wherein the thio-containing compound is added before, after, and/or with the nitrogen-containing alicyclic compound.

6. The method of claim 1, wherein the metal surface comprises steel, iron, copper, brass, and any combination thereof.

7. The method of claim 1, further comprising adding an effective amount of an additional component to the medium, wherein the additional component is selected from the group consisting of a fouling control agent, an additional corrosion inhibitor, a biocide, a preservative, an acid, an anti-emulsifier, an iron chelating agent, a hydrogen sulfide scavenger, a surfactant, an asphaltene inhibitor, a paraffin inhibitor, a scale inhibitor, a gas hydrate inhibitor, a pH modifier, an emulsion breaker, a reverse emulsion breaker, a coagulant/flocculant agent, an emulsifier, a water clarifier, a dispersant, an antioxidant, a polymer degradation prevention agent, a permeability modifier, a foaming agent, an antifoaming agent, a CO₂ scavenger, an O₂ scavenger, a gelling agent, a lubricant, a friction reducing agent, a salt, and any combination thereof.

8. The method of claim 1, wherein a solvent comprises the thio-containing compound and/or the nitrogen-containing alicyclic compound.

9. The method of claim 8, wherein the solvent is selected from the group consisting of water, a C₁-C₆ alkanol, a C₁-C₆ alkoxyalkanol, an alcohol, a glycol ether, a hydrocarbon, a ketone, an ether, an aromatic, an alkylene glycol, an amide, a nitrile, a sulfoxide, an ester, and any combination thereof.

10. The method of claim 1, wherein the thio-containing compound is thioglycolic acid.

11. A composition, comprising:
a medium,
a nitrogen-containing alicyclic compound, and
a thio-containing compound,
wherein the medium comprises produced water, fresh water, recycled water, salt water, surface water, condensed water, cooling water, injection water, waste water, geothermal waters, sewage water, nuclear cooling water, or any mixture thereof, and
wherein the nitrogen-containing alicyclic compound is selected from the group consisting of piperazine, aziridine, azetidine, azepane, quinuclidine, pyrrolidine, piperidine, dihydroazete, diazetidine, triazinane, and any combination thereof.

12. The composition of claim 11, wherein the thio-containing compound is selected from the group consisting of 2-mercaptoethanol, thioglycolic acid, a thiosulfate, and any combination thereof.

13. The composition of claim 11, wherein the composition comprises from about 0.5 wt. % to about 99 wt. % of the nitrogen-containing alicyclic compound and from about 0.5 wt. % to about 99 wt. % of the thio-containing compound.

14. The composition of claim 11, wherein a metal surface comprises the composition.

15. The composition of claim 11, further comprising an additional component selected from the group consisting of a fouling control agent, an additional corrosion inhibitor, a biocide, a preservative, an acid, an anti-emulsifier, an iron chelating agent, a hydrogen sulfide scavenger, a surfactant, an asphaltene inhibitor, a paraffin inhibitor, a scale inhibitor, a gas hydrate inhibitor, a pH modifier, an emulsion breaker, a reverse emulsion breaker, a coagulant/flocculant agent, an emulsifier, a water clarifier, a dispersant, an antioxidant, a polymer degradation prevention agent, a permeability modifier, a foaming agent, an antifoaming agent, a CO₂ scavenger, an O₂ scavenger, a gelling agent, a lubricant, a friction reducing agent, a salt, and any combination thereof.

16. The composition of claim 11, further comprising a solvent selected from the group consisting of water, a C₁-C₆ alkanol, a C₁-C₆ alkoxyalkanol, an alcohol, a glycol ether, a hydrocarbon, a ketone, an ether, an aromatic, an alkylene glycol, an amide, a nitrile, a sulfoxide, an ester, and any combination thereof.

17. The composition of claim 11, further comprising a pH from about 2 to about 10.

18. A method of reducing an amount of hydrogen sulfide, comprising:
adding a nitrogen-containing alicyclic compound to a medium, the medium comprising hydrogen sulfide and a thio-containing compound,
reacting the nitrogen-containing alicyclic compound with the thio-containing compound and/or the hydrogen sulfide, and
reducing an amount of hydrogen sulfide in the medium.

19. The method of claim 18, wherein the nitrogen-containing alicyclic compound is selected from the group consisting of
piperazine, aziridine, azetidine, azepane, quinuclidine, pyrrolidine, piperidine, dihydroazete, diazetidine, triazinane, and any combination thereof.

20. The method of claim 18, wherein the thio-containing compound is selected from the group consisting of 2-mercaptoethanol, thioglycolic acid, a thiosulfate, and any combination thereof.
